(19) United States
(12) Patent Application Publication
(10) Pub. No.: US 2009/0293587 A1
(43) Pub. Date: Dec. 3, 2009

(54) Impact power measuring device

(76) Inventor: Engelbert Mages, Furth/Vach (DE)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/662,789

(22) PCT Filed: Sep. 15, 2005
(86) PCT No.: PCT/EP05/09940

§ 371 Date: Mar. 14, 2007

(30) Foreign Application Priority Data
Sep. 17, 2004 (DE) 10 2004 045 188.5

(51) Int. Cl. G01N 3/30

(52) U.S. Cl. 73/12.01; 702/41

(57) ABSTRACT

An impact force measuring means (4) comprising several measuring chambers (24) which are provided in an elastic material and are disposed and designed such that a blow to be measured and hitting at least one of the measuring chambers (24) changes the volume thereof, a discharge line (8) connected to the measuring chambers (24), and a sensor (12) disposed in said discharge line (8), characterized in that there are provided additional chambers (30) that are not connected to said discharge line (8) containing said sensor (12).

The present invention relates to an impact force measuring means comprising several measuring chambers which are provided in an elastic material and are disposed and designed such that a blow to be measured and hitting at least one of the measuring chambers changes the volume thereof, a discharge line connected to the measuring chambers, and a sensor disposed in said discharge line.

Such an impact force measuring means is known from EP 1 090 661 A1. This publication teaches the provision of a sensor as temperature-responsive resistor for measuring the flow in the discharge line. Sensors of this kind have various disadvantages. On the one hand, they are relatively expensive and relatively bulky, with both of these aspects being of disadvantage for realizing impact force measuring means that are accepted by the market. By far more problematic is the inertia inherent to such sensors. In case of martial arts, e.g. taekwondo, the competitors try to land blows with their hands or feet in accordance with certain rules, with blows or hits being counted as of a specific impact force only. Up to three or four blows per second are not seldom, and an impact force measuring means has to be capable of resolving these impacts and of processing them individually. With such a high impact frequency, however, one has reached a borderline range in which such temperature-responsive resistors can still be used to advantage, and while some single events still may be resolved individually, others are melted together into one impact event. Such unreliable impact force measuring means cannot be used in practicable application and are unsuitable.

The “open system” described in EP 1090 661 A1, in which the fluid contained in the system can flow off in substantially unhindered manner from the system during the measurement and subsequent to the end of the blow flows back to the system typically through the discharge line, is a development of the impact force measuring means of the same developer group, as described in EP 1 033 152 B1, which was abandoned as it turned out too unreliable. In particular, said EP 1 033 152 B1 describes a “closed system” with a pressure measuring sensor in which the fluid of the discharge line cannot flow off from the system, but is retained in the system. The discharge line could also be omitted, as it merely serves to position the pressure sensor in spatially distant manner from the impact region so as to avoid injury to the competitors by the hard sensor. The discharge line in said device is just a closed branch line that does not allow unhindered fluid flow-off. The publication indeed suggests to use ambient pressure in the system as otherwise the construction would have to be absolutely gastight. Said closed system nevertheless is so gastight that, by increase or decrease of the ambient pressure or heating of the gas by the body heat of the sportsman, measurement inaccuracies occur that do not permit a reproducible evaluation of the pressure measuring signals.

It is therefore an object of the invention to make available an impact force measuring means in which individual impacts with high impact frequency can be reliably resolved and the disadvantages inherent to the closed system can be avoided.

In accordance with the invention, this object is met in that in addition to the measuring chambers there are provided additional chambers that are not connected to the discharge line containing the sensor.

It has been found out surprisingly that, with such an alternating arrangement of measuring chambers and additional chambers, the pressure sensor generates a measurement signal containing particularly much information and permitting particularly good evaluation. In particular, such an arrangement permits a finer resolution of impacts with respect to the sequence in time and the impact force of the same. The additional chambers may be designed substantially in the same manner as the measuring chambers. However, they are not connected to the pressure sensor via the discharge line. The additional chambers e.g. may each be closed in themselves or may be connected to the environment via separate discharge lines.

The measuring chambers and the additional chambers may be provided in a plate-like measuring body composed of a resiliently elastic material. The plate-like measuring body may be incorporated in a combat vest e.g. in the form of a layer or may be incorporated in a training device. The plate-like design provides the advantages that the measuring body may be relatively thin. In addition thereto, such a plate-like measuring body is relatively easy to manufacture.

The measuring chambers may be elongate and may have a substantially constant cross-sectional area. The additional chambers may be designed in the same manner.

The measuring chambers and the additional chambers may all be arranged in one common plane e.g. substantially with the same distance from the surface of the elastic material.

The measuring chambers and/or the additional chambers may be of round cross-section e.g. with a diameter of approx. 2 to 7 mm, with the mutual spacing between the measuring chambers and/or the additional chambers being approx. 1 to 5 mm and the measuring chambers and/or the additional chambers being provided in a plate-like measuring body with a thickness of approx. 5 to 15 mm such that the distance from the impact side of the measuring body is at least 0.5 mm and preferably approx. 1 to 3 mm. Instead of with a round cross-section, the measuring chambers may also be provided with an oval or rectangular cross section. A round cross-section has turned out advantageous in particular for reasons of manufacturing technology. The discharge line preferably is formed with a round cross section as well. The discharge line may have a diameter of approx. 2 to 10 mm, preferably in the range from approx. 3 to 5 mm. In case of cross sections other than round ones, the measures indicated for the diameter are to be understood to the effect that corresponding cross-sectional areas of flow are formed with such other, non-round cross sections. It is also possible to provide several layers of measuring chambers and/or additional chambers on top of each other, e.g. one additional layer of additional chambers only may be provided which renders possible improved impact attenuation. It is also possible to arrange each of the, in layers, parallel measuring chambers and additional chambers of the different layers at an angle of e.g. 90° relative to each other if the measuring chambers are elongate ones.

The sensor may be a temperature-, acceleration- and/or position-compensated sensor, in particular a pressure sensor. However, it is also possible to use an anemometer, e.g. a temperature-responsive resistor, for flow measurement. By way of the specific arrangement of the measuring chambers and the additional chambers, sufficient results may be achieved with such a sensor as well.

A significant problem in using a sensor in an impact force measuring means consists in taking measures to the effect that the sensor measures only the pressure changes caused by the impact and, in particular, that positional changes and accelerations caused by the combat activities, such as blows etc., do not have an effect on the sensor signal.

The pressure sensor may be a double-chip sensor, i.e. it may have two electrically antiparallel sensor elements of which only one is connected to the measuring chambers, and there may be provided a semiconductor element. The other sensor element, that is not connected to the measuring chambers, may be connected to the environment. The two sensor elements, like twins, are of substantially identical design and in essence are arranged such that, presupposing the same cause, identical signals are generated. By way of the antiparallel electrical connection of the individual sensor elements, sensor signals due to position, acceleration and/or temperature cancel each other, and as signal generated by the sensor there is just remaining the change in volume or pressure fluctuation that is due to the blow. The semiconductor sensor may have a semiconductor membrane, with the deformation of the same under the influence of pressure being used for pressure measurement. The pressure sensor may have a measuring space which, with one wall thereof, is constituted by the membrane and which has a connecting means for connecting the discharge line, but is otherwise closed. In particular, the discharge line may open into the measuring space so that the discharge line is closed by the measuring space in the manner of a dead end. The membrane may be open to the environment on its side opposite the measuring space. The pressure fluctuations thus are applied to the membrane directly, permitting the relative pressure with respect to the environment to be measured (“dynamic pressure measurement”). In case of a pressure sensor with two sensor elements connected antiparallel, only the membrane of one sensor element is connected to the discharge line. The membrane of the second sensor element may be open to the environment on both sides, so that the membrane of the second sensor element detects only effects caused by temperature changes, positional changes and/or acceleration and compensates the corresponding signals of the other sensor element. This feature, i.e. the utilization of a pressure sensor with two electrically antiparallel sensor elements as pressure sensor for an impact force measuring means, is considered inventive as seen alone, i.e. without all or just with part of the features of claim 1.

Instead of a dynamic pressure measurement, it is also possible to perform an indirect measurement of the pressure fluctuations by way of the flow quantity. To this end, the pressure drop across a known throttling means in the discharge line, e.g. a diaphragm, a constriction, a Venturi path etc., is measured. From the pressure drop, it is possible to determine the pressure fluctuation caused by this flow. The compensated double-chip sensor may be employed for this measurement as well.

For example, one sensor element may be used to measure the relative pressure between a location ahead of the throttling means and a location subsequent to the throttling means, whereas the other sensor element serves for compensation. It is also possible to use one sensor element for measuring the relative pressure with respect to the environment ahead of the throttling means and to use the other sensor element for measuring the relative pressure with respect to the environment subsequent to the throttling means, but to this end it is necessary to connect the respective opposite sides of the membrane to the discharge line.

There may be provided several discharge lines and/or several pressure sensors of the impact force measuring means. The pressure sensor preferably is highly sensitive and preferably has a measuring range of <100 mbar, preferably 75 mbar at maximum. It is preferably an absolute pressure sensor. The present invention, instead of the quantity of flow through the discharge lines, thus makes use of the pressure fluctuations in the discharge line caused by an impact or blow for measuring the impact force.

The discharge line preferably is opened to the environment subsequent to the pressure sensor. The fluid in the system thus may flow off to the environment through the discharge line, e.g. in case of a blow but also in case of movement of the competitor, in case of air pressure fluctuations or in case of changes in volume due to temperature changes. In corresponding manner, the fluid may also flow back into the system through the discharge line. However, it is also conceivable in general that the fluid, subsequent to the pressure sensor, flows off to a closed, large-volume chamber.

The elastically resilient material preferably is a foamed plastics material with high and fast recovery capacity. The recovery capacity in particular has to be sufficiently high and fast to accommodate the high impact frequency. The almost complete recovery after an impact preferably takes place within a period of less than 0.45, less than 0.3 s and preferably within a period of 0.25 s and less. A suitable plastics material is polyurethane, for example.

The discharge line, at least in portions thereof, may be formed of the elastically resilient material. In particular, the discharge line may be formed integrally with the measuring chambers and/or the additional chambers during manufacture, so that it is possible for the same to be integrated in the plate-like measuring body as well.

The discharge line may be reinforced such that blows applied to the discharge line in the corresponding reinforced region do not deliver indicated impacts or scores. The reinforcement e.g. may be provided such that a substantially pressure-resistant hose is used.

The impact force measuring means may comprise furthermore a microprocessor to which the measuring signals of the pressure sensor are transferred and which is designed such that it can determine the impact quality therefrom. In particular, the change in pressure over time in the discharge line may be the measure to be evaluated from which the impact quality can be determined. It is thus possible to distinguish between impacts and impact forces on the basis of the ascending slope of the pressure derivative with respect to time. The impact quality on the one hand relates to the force and on the other hand relates to the speed of the blow performed. In particular the impact force is the relevant criterion of assessment e.g. in case of taekwondo. The assessment in particular is made by assigning points on the basis of the impact force of landed blows or hits.

The microprocessor may be designed such that it identifies measuring signals as blows only when a threshold value is exceeded, and then subjects the same to further evaluation. This microprocessor threshold value serves to eliminate from the very beginning pressure fluctuations occurring due a discharge flow when the sportsman is moving or due to extremely weak contacts. In this manner, the microprocessor is put into operation only when the pressure is in excess of this threshold value.

The microprocessor may be designed such that it is capable of classifying blows to different categories in accordance with the force applied in the blow. In taekwondo, for example, blows are counted only when a certain minimum impact force is exceeded, which typically is dependent on the weight classes. Accordingly, the impact force measuring means or the microprocessor advantageously is designed such that it awards a point only when this minimum value is exceeded. Optionally, it is also possible to award several points to each blow in case the blow is landed with particularly high force. The impact force measuring means thus is capable of objectively assigning points to each blow.

The microprocessor may be designed such that it has an evaluation routine subjecting the measuring signals to a Fourier transform or to an integration. The Fourier analysis is particularly favorable as it permits very well to analyse the curve shape of the blows and to derive hints therefrom in particular for training purposes. Thus, it is possible in general to make a distinction between fast, i.e. technically good, slow and pushing blows. The measuring signal abruptly rises after a blow and then oscillates in attenuated manner about the offset voltage of the pressure sensor. The Fourier transform is particularly suitable for evaluating such a measuring signal. For determining the impact force alone, it is sufficient to perform an calculation of area after full-wave rectification of the curve. Other evaluation processes are conceivable as well. This feature alone also is deemed inventive.

There may be provided a buffer memory for temporarily storing measuring signals prior to processing by the microprocessor. It is advantageous to exploit also those portions of the measuring signal that are detected before the microprocessor threshold value is exceeded. In this manner, it is possible to use the entire increase immediately after the blow for evaluation as well. As soon as the microprocessor, upon exceeding of the microprocessor threshold value, has identified a measuring signal as a blow, it will retrieve earlier values from the buffer memory and incorporate the same in the evaluation as well.

The buffer memory may be a ring buffer.

The invention relates furthermore to a combat vest, boxing gloves and a blow training device, respectively, e.g. a sand bag or a punching bag, comprising an impact force measuring means according to the present invention. The invention is applicable in particular also for boxing gloves. The boxing sport involves a high risk of injury. Thus, there again and again serious head injuries due to blows on the head. The use of boxing gloves with an impact force measuring means permits an objective evaluation of a blow, irrespective of the effect of a blow on an opponent. Thus, the impact force measuring means may be arranged e.g. very close to the first in the boxing glove, and outside of the impact force measuring means there may be a very good padding that may significantly minimize the effect of the blows on the opponent.

Furthermore, the invention relates to a competition and/or training evaluation device for use with combat vests according to the present invention, to be worn by martial arts competitors, and a computer fed with the impact data of the two combat vests, the computer being designed such that it is suitable to detect the impact data, to calculate scoring points from the impact data and to further process the scoring points in association with the individual competitors and to finally ascertain the winner. In this manner, it is possible to realize a very objective kind of competition assessment.

The invention and developments of the invention will be described in the following by way of an embodiment shown in the drawings in which:

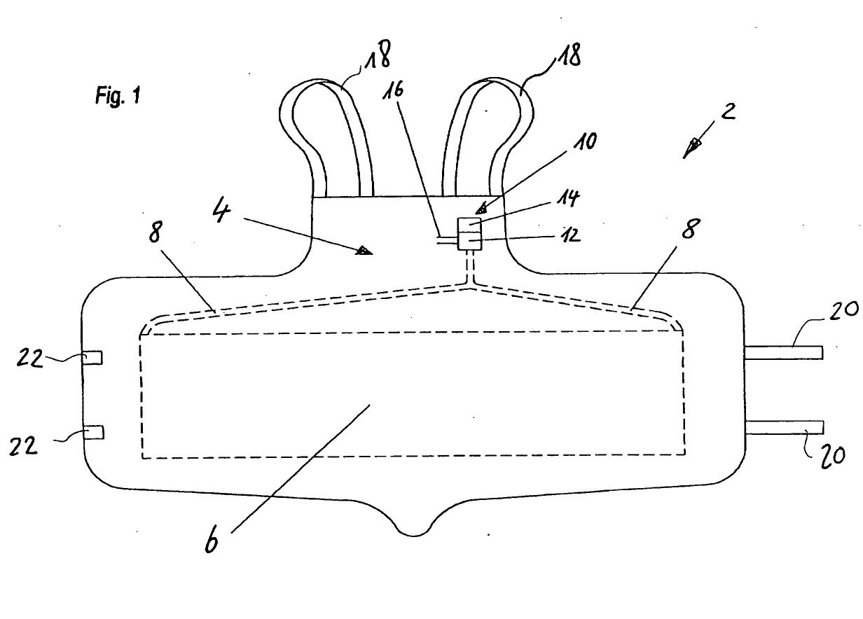

FIG. 1 shows a combat vest for a martial arts sport such as taekwondo;

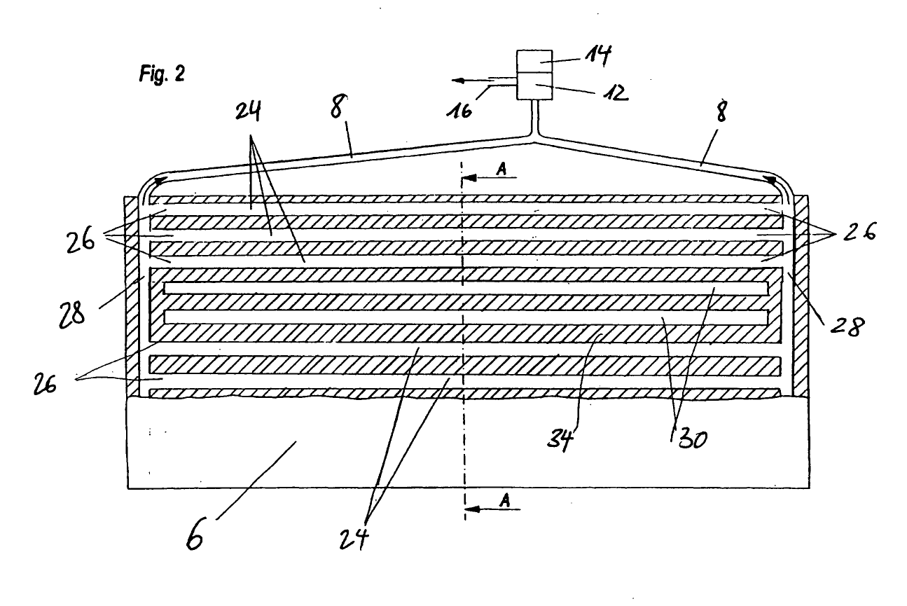

FIG. 2 shows an enlarged illustration of the impact force measuring means in the combat vest of FIG. 1;

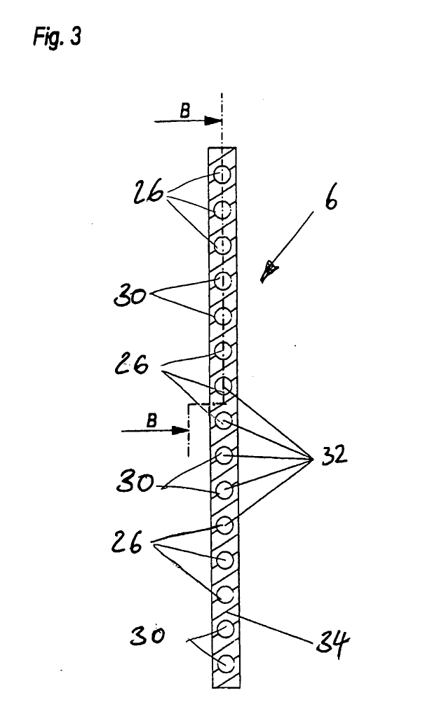

FIG. 3 shows a section through the measuring body of the impact force measuring means of FIG. 2 along the line A-A;

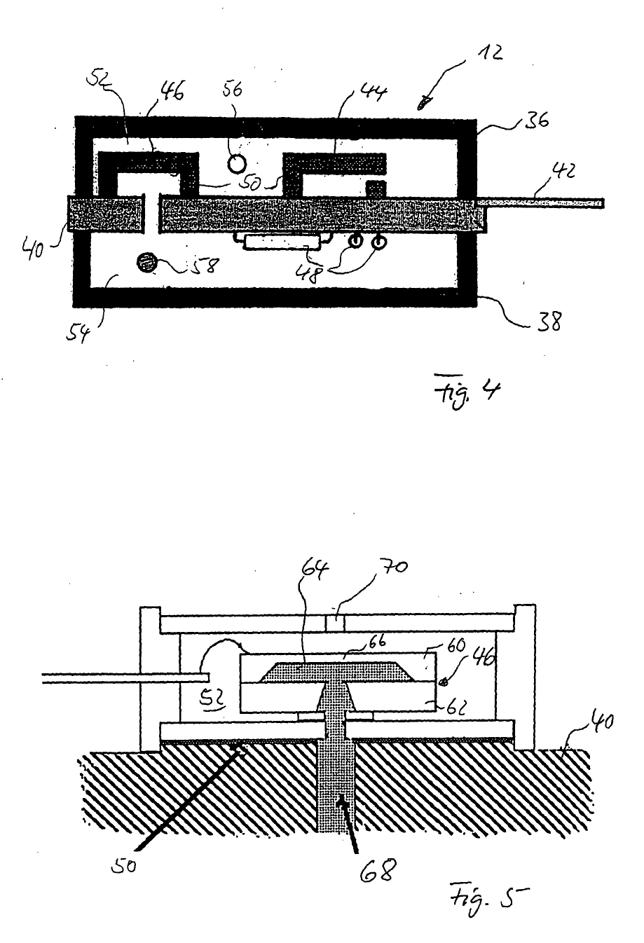

FIG. 4 shows a schematic sectional view of a pressure sensor in double-chip technology; and

FIG. 5 shows a schematic sectional view of a pressure sensor in single-chip technology.

FIG. 1 shows a combat vest for takewondo. Combat vest 2 has an integrated impact force measuring means 4. The impact force measuring means 4 consists in essence of a plate-like or mat-like measuring body 6 that is either integrated in the textile material of the combat vest 2 or is arranged on the textile material on the inside or the outside of the combat vest 2. In the embodiment illustrated, the plate-like measuring body 6 is arranged in the textile material of the combat vest, as indicated by the broken lines.

The plate-like measuring body 6 is connected to a measuring means 10 by means of two discharge lines 8. In particular, the measuring means 10 comprises a pressure sensor 12 and a processing and/or transmitting means 14. Pressure sensor 12 is connected to the environment via a short piece of line 16. This means that the impact force measuring means 4 shown in the drawings is an “open system”, i.e. the measuring chambers arranged in the measuring body 6 are in substantially unobstructed fluid communication with the environment, via the discharge lines 8, the pressure sensor 12 and the exit line 16 from pressure sensor 12. The pressure sensor 12 in essence measures only the pressure fluctuation in the fluid through the discharge lines 8, which is induced to oscillate due to the blow.

As an alternative, the pressure sensor 12 terminates the discharge line 8, and the short piece of line 16 provides a connecting means for reference ambient pressure up to pressure sensor 12.

The pressure sensor 12 employed is a high-sensitivity pressure sensor, preferably an absolute pressure sensor having a relatively low measuring rane, e.g. up to less than 100 mb. A low-pressure sensor of the series ACLA of the company ASensTec GmbH in double-chip technology with amplifier has turned out be be particularly suitable. These sensors fulfil the general requirements to be met by sensors for such applications, i.e. positional independency, precision, long-term stability as well as temperature compensation. The sensors will be described in more detail hereinafter with reference to FIGS. 4 and 5.

Electronic compensation for eliminating environmental effects, measurement errors etc. may be provided in the processing and/or transmitting means 14 as well.

The discharge lines 8 from the measuring body to the pressure sensor 12 are reinforced, so that blows on these discharge lines 8 do not generate a fluid signal at pressure sensor 12 and thus are not recorded.

The pressure sensor 12 and the processing and/or transmitting means 14 preferably are disposed on the back, e.g. in the region of the shoulder or the neck of vest 2, as far as possible away from the impact or scoring zones determined for the particular sport. The measuring range of the measuring body 6 accordingly covers preferably exactly the corresponding impact zones. Vest 2 preferably is designed as a protective vest in order to mitigate the effects of the blows on the body. Vest 2 has straps 18 allowing the same to be worn across the shoulder. In addition thereto, it has attachment straps 20 permitting, together with corresponding counter pieces 22, safe attachment of the vest to the body.

In the processing and/or transmitting means 14, the measuring signals of the pressure sensor 12 are either directly transmitted to an external evaluation circuit. Suitable for the data transfer is e.g. a radio connection, e.g. in blue-tooth technology, or any other kind of radio connection. A wire connection is conceivable as well, in particular when, as in fencing, motions are performed in one direction only or when the impact force measuring means is used in a fixedly installed training device. It is also possible to merely store the measuring data and to retrieve and evaluate the same only after the end of the contest. It is possible as well to evaluate the measuring signals in the processing and/or transmitting means 14 and to transmit only the evaluated results. It is thus conceivable, for example, that only the vigor of a blow, e.g. “250 kP”, is transmitted while there is no other signal transmitted, thus reducing the power consumption of the impact force measuring means. The power demand of the impact measuring means 4 may be supplied e.g. by a battery included therein.

It may be favorable to provide a means checking the reliability of the transmitting connection, e.g. by numbering the blows of a combat for each competitor in ascending manner, and to transmit this index number of the blow as well, e.g. in the form of “1 250 kP”, and to transmit in addition the total number of the blows for each competitor at the end of the competition. Thus, it is at least possible on the side of the recipient to check for each blow whether the previous blow was landed. It may be advantageous to store the transmitted information in the impact force measuring means in addition, so that it is definitely possible after the combat to obtain the complete data.

In particular, the processing and/or transmitting means 14 in essence may have a construction in which, depending on the type of pressure sensor 12, the measuring signals of the pressure sensor 12 are supplied via an amplifier to an A/D converter. Amplifier and A/D converter are optional and may be dispensable at least when the pressure sensor 12 has an amplifier of its own and/or when the pressure sensor 12 already issues digital signals. The digitalized measuring signals are fed to a buffer memory, e.g. a ring buffer, and it is examined substantially at the same time whether a predetermined threshold value is exceeded as of which a measuring signal is identified as a “blow”. This threshold value should be chosen such that usual pressure fluctuations, resulting e.g. due to movement of the competitor, are not understood as “blow”. When this measuring value is exceeded, the measuring signals of a certain predetermined measurement interval are used for calculation and evaluation of the blow. This measurement interval in particular comprises also measuring signals from a period of time prior to exceeding of the threshold value in order to evaluate the entire ascent of the measuring signal which comprises essential information on the blow. The evaluation proper then may be performed e.g. by means of a Fourier analysis or by a calculation of area after full-wave rectification of the curve, preferably about the offset voltage of pressure sensor 12 as zero value. The data thus ascertained are reproducible and, upon corresponding calibration, may exactly indicate the impact force of the respective blow in kP.

FIGS. 2 and 3 illustrate in particular the measuring body 6 in more detail. The measuring body 6 is made of an elastic plastics material with good recovery properties, e.g. polyurethane PU. A foamed plastics material, as used also for the production of elastic upholstery materials, e.g. in the motor vehicle and furniture industry, has turned out to be particularly suitable. The solid material preferably has a density of 200 to 600 kg/m³ and a Shore A hardness of 20 to 50, optionally also up to approx. 80 or approx. 90. A suitable material is, for example, Elastofoam I 309/098/OF of the company Elastogran, having a mold part density of 200 to 600 kg/m³ in case of an elastic integral foamed part. An alternative material are cross-linked rubber-like materials that may be used in foamed or unfoamed form. Such a material is e.g. cross-liked thermoplastic elastomer, TPE-V. The material may be fully cross-linked or partially cross-linked, e.g. up to approx. 98 percent. There may be used a cross-linked PP-EPDM alloy as offered e.g. under the trade name Forprene. The measuring body 6—either in the foamed form or in the unfoamed form—preferably has a Shore hardness of approx. 30 to 70, 40 to 60, 45 to 55 or approx. 50. Such a Shore hardness in case of foamed materials may be reached with different Shore hardnesses of the starting material. In case of foamed material, a specific gravity of approx. 0.76 kg/dm³ of the measuring body 6 may be achieved, which is approx. 0.98 kg/dm³ in case of solid material.

The measuring body 6 according to the present embodiment has a plate-like or mat-like configuration and is relatively flat so that it can easily be incorporated in a combat vest etc. A thickness of about 7 to 9 mm, preferably 8 mm, has turned out successful. The measuring body 6 has measuring chambers 24 formed therein, extending substantially across the entire length of measuring body 6. The measuring chambers 24, at the location indicated by numeral 26, open into the portion 28 of discharge line 8 that is arranged within the measuring body 6. A throttling means may be provided at this opening location. However, it seems to be preferable to have no throttling locations in the system in order to permit as undisturbed flow as possible. Portion 28 of the discharge line 8 has the function of a collecting line or manifold. In FIG. 2, both ends of measuring chamber 24 open into discharge line 8. It is in general sufficient to have only one end of measuring chambers 24 open into discharge line 8. FIG. 2 also reveals that there are additional chambers 30 provided in the measuring body that do not open into discharge line 8. It has surprisingly turned out that the measuring signals of pressure sensor 2 are distinctly better when not all chambers 24, 30 are connected to discharge line 8. It has turned out particularly advantageous when the number of measuring chambers 24 is slightly higher than the number of additional chambers 30. Moreover, it has turned out advantageous to provide a regular rhythm between the arrangements of measuring chambers 24 and additional chambers 20. It is particularly advantageous to provide a sequence of X, Y, X, Y . . . , wherein X>Y, with X designating the measuring chambers 24 and Y designating the additional chambers 30. It seems to be particularly advantageous when X=3 and Y=2, as also shown in FIG. 2. It is also possible to connect the additional chambers to a discharge line (not shown) and to feed the same to a pressure sensor of their own. It is thus possible to increase the system redundancy and to realize an enhanced and more accurate impact evaluation.

Measuring chambers 24 as well as additional chambers 30 having a substantially uniform cross-section in longitudinal direction, e.g. a circular cross-section, have turned out preferable in terms of manufacturing technology and with respect to the measuring signal quality. A suitable diameter for the chambers is about 5 mm, and a suitable distance between two chambers is about 3 mm.

In case of a blow on the measuring body 6, the latter is elastically deformed and, during relaxation, oscillates slightly with respect to its original configuration. This dynamic motion of the measuring body 6 is passed by the air in the measuring chambers 24 through pressure sensor 12 via discharge line 8. Differently from a “closed” system in which a pressure sensor on a measuring line measures and evaluates the pressure built-up in the fluid and the air, respectively, the present invention measures the pressure fluctuations resulting from the oscillations of the measuring body 6, and measures not only the singular pressure built-up as measured in the prior art using pressure sensors for “closed systems”.

FIG. 3 shows a sectional view of the measuring body 6 of FIG. 2 along the line A-A. The sectional view of FIG. 3 illustrates the measuring body 6 and the measuring chambers 26 and the additional chambers 30 arranged in a regular sequence.

Numeral 32 therein designates the chambers in general, and numeral 34 designates a web between two chambers 32.

FIG. 4 illustrates a schematic cross-sectional view of a pressure sensor 12 in double-chip technology. In particular, it is possible to recognize a housing having two shell halves 36, 38 on both sides of a circuit board 40. Circuit board 40 may be made of an arbitrary suitable material, with a preferred material being ceramics. Extending from circuit board 40 is a connecting line 42 for supplying power to sensor 12 and also for passing the measurement data. Circuit board 40 has two sensor elements 44, 46 arranged thereon substantially in mutually aligned manner. Moreover, it is possible to discern additional components 48 which, in particular, may comprise an amplifier. The “stilts” 50 by means of which the sensor elements 44, 46 are joined to circuit board 40 are a permanently elastic adhesive material through which the sensor elements 44, 46 are adhered to circuit board 40. The mechanical effects of the blows on the sensor elements 44, 46 thus may be attenuated relatively well or the sensor elements 44, 46 may be uncoupled therefrom relatively well, which increases the measurement accuracy and provides additional protection for the sensor elements 44, 46 against too strong vibrations.

The two shell halves 36, 38 are closely joined to the circuit board 40 such that a space 52, 54 is formed on both sides of circuit board 40. The spaces 52, 54 are mutually sealed, and a connecting means 56, 58, e.g. for discharge line 8, is provided for each space 52, 54.

The construction and the functioning of a sensor element 44, 46 will be explained in the following with reference to FIG. 5. In general, FIG. 5 shows a pressure sensor 12 in single-chip technology. It is generally possible as well to use such a pressure sensor 12 in single-chip technology for the present invention, e.g. with separate e.g. electronic temperature, acceleration and/or positional compensation. Similar to the representation of FIG. 4, sensor element 46 is attached on a firm basis, e.g. a circuit board 40, by means of a permanently elastic adhesive. Sensor element 46 has in essence two plate-like mutually connected sensor halves 60, 62. The upper sensor half 60, which typically consists of silicon single-crystal material, has a recess 64 formed therein by anisotropic etching, so that in the region of this recess 64 there is present only a relatively thin measuring membrane 66 which, in plan view, typically is of rectangular or square cross-section. Four resistors responsive to tensile and compressive stress, respectively, are provided on membrane 66 and are connected to each other in the manner of a Wheastone bridge. It is thus possible to measure extremely small deformations of the membrane 66. The lower sensor half 62 protects and stabilizes membrane 66. The two sensor halves 60, 62 are firmly joined together. In the ideal state, said lower and upper sensor halves 60, 62 behave as if they consisted of one single single-crystal. By way of an opening 68 in said lower sensor half 62, the recess or measuring space 64 can be connected to a connecting means (not shown). Space 72 on the other side of membrane 66 is connected to the environment by way of passage 70, so that the sensor element 46 measures the relative pressure in the measuring space 64 with respect to the environment (“dynamic pressure measurement”).

The double-chip sensor 12 or the sensor element 46 of FIG. 4 may be used for dynamic pressure measurement in similar manner when discharge line 8 is connected to connecting means 58 and connecting means 56 is in communication with the environment e.g. via line 16. When there is blow on measuring body 6, the sensor element 46 is capable of measuring the relative pressure with respect to the environment and in particular the pressure increase and the pressure pattern in terms of time, respectively, and it is possible to use the same for impact evaluation.

In this regard, the membrane 66 of the second sensor element 44 is in contact with connecting means 56 only, so that the pressure ideally is the same on both sides of the membrane. However, membrane 66 of the second sensor element 44 is substantially parallel and aligned in a plane with the plane of the first sensor element 46. Accordingly, membrane 66 is subject to all other influential parameters acting also on the first sensor element 46, but affecting the measuring result and thus being undesired, such as acceleration, temperature change, positional change etc. By way of a simple electrically antiparallel connection of both sensor elements, these interfering factors may be compensated easily and reliably.

Instead of the dynamic pressure, it is also possible to obtain pressure data for impact evaluation from the flow quantity by way of a predetermined throttling means in discharge line 8. To this end, connecting means 56 and 58 are connected to discharge line 8 at a location upstream and downstream, respectively, of the throttling means so that the sensor element 46 measures the relative pressure or the pressure differential across the throttling means, respectively. In this regard, sensor element 44 merely serves for compensation as well. Pressure differential measurement is possible in similar manner also with the sensor of FIG. 5 via the fixed throttling means.

The data transmitted or transferred via cable are preferably passed e.g. via a receiving module to a computer, preferably a conventional personal computer, and are evaluated there. The computer e.g. has a program running thereon containing the frame conditions of a competition, such as e.g. round times, break times etc. as well as the different weight classes and the assessment of the blows possibly also as a function of the weight classes. The data of the combat vests of the sportsmen are processed by the PC so that the PC may indicate a current assessment of the combat between the two competitors. The data preferably are transferred in real time to the PC or optionally several PCs so that the judge/s may compare a blow detected by the impact force measuring means with what they actually see and hear from the competitors. The judge/s thus is/are capable of examining the plausibility of the measurement results of the impact force measuring means 4. Moreover, the program on the PC may be designed such that it is adapted to process the entire competition schedule including all preliminary competitions, quarter-final, semi-final and final competitions, in accordance with the particular mode applicable for the competitions, optionally inclusive of the drawing of the competitors and the setting up of the result lists. The processing and/or transmitting means 14 or the PC, respectively, may also be capable of performing a data-technical evaluation of the impact characteristics e.g. for distinguishing the blows for training control in accordance with rapid, technically good and, respectively, slow or pushing blows, thus permitting a very direct feedback for the training sportsman with respect to the quality of the blows and not only with respect to the maximum impact force or vigor. Corresponding data, of course, may be recorded during a competition as well and may be utilized for further training control.

1. An impact force measuring means (4), comprising:
several measuring chambers (24) which are provided in an elastic material and are disposed and designed such that a blow to be measured and hitting at least one of the measuring chambers (24) changes the volume thereof;
a discharge line (9) connected to the measuring chambers (24);
a sensor (12) disposed in said discharge line (8); and
additional chambers (30) that are not connected to said discharge line (8) containing said sensor (12).

2. The impact force measuring means (4) according to claim 1 wherein said measuring chambers (24) and said additional chambers (30) are provided in a plate-like measuring body (6).

3. The impact force measuring means (4) according to claim 2, wherein said measuring chambers (24) are elongate and have a substantially uniform cross-section.

4. The impact force measuring means (4) according to claim 3, wherein said measuring chambers (24) and said additional chambers (30) are of substantially identical configuration.

5. The impact force measuring means (4) according to claim 3, wherein said measuring chambers (24) and said additional chambers (30) are arranged substantially in one plane.

6. The impact force measuring means (4) according to claim 3, wherein said measuring chambers (24) and said additional chambers (30) are arranged in a regular rhythm.

7. The impact force measuring means (4) according to claim 6, wherein said measuring chambers (24) and said additional chambers (30) are arranged in a sequence X, Y, X, Y, . . . , with X designating the number of measuring chambers (24) and Y designating the number of additional chambers (30), and wherein X>Y.

8. The impact force measuring means (4) according to claim 7, wherein X=3 and Y=2.

9. The impact force measuring means (4) according to claim 3, wherein at least one of said measuring chambers (24) and said additional chambers (30) is of round cross-section with a diameter of approx. 3 to 7 mm, the distance between measuring chambers (24) and additional chambers (30) is approx. 1 to 5 mm and said measuring chambers (24) and said additional chambers (30) are provided in a plate-like measuring body (6) with a thickness of approx. 5 to 15 mm such that the distance from the impact side of the measuring body (6) is approx. 1 to 3 mm.

10. The impact force measuring means (4) according to claim 9, wherein said sensor is a temperature-, acceleration- and position-compensated pressure sensor (12).

11. The impact force measuring means (4) according to claim 10, wherein said pressure sensor (12) has two sensor elements that are electrically connected in antiparallel manner.

12. The impact force measuring means (4) according to claim 10, wherein said pressure sensor is a semiconductor sensor.

13. The impact force measuring means (4) according to claim 10, wherein said discharge line (8) subsequent to said pressure sensor (12) is open to the environment.

14. The impact force measuring means (4) according to claim 1, wherein the elastic material is a foamed plastics material with high and rapid recovery capacity.

15. The impact force measuring means (4) according to claim 14, wherein said discharge line (8) is at least in portions formed of said elastically resilient material.

16. The impact force measuring means (4) according to claim 14 wherein said discharge line (8) at least in portions is reinforced such that impacts on said discharge line (8) in the corresponding region do not result in scores being indicated.

17. The impact force measuring means (4) according to claim 1, further comprising a microprocessor to which the measuring signals of said sensor (12) are transferred and which is designed such that it is capable of determining the impact quality therefrom.

18. The impact force measuring means (4) according to claim 17, wherein said microprocessor is designed such that it identifies and further evaluates measuring signals as “impact” only when a threshold value is exceeded.

19. The impact force measuring means (4) according to claim 17, wherein said microprocessor is designed such that it is able to classify impacts to different categories in accordance with the force applied in landing the blow.

20. The impact force measuring means (4) according to claim 17, wherein said microprocessor is designed such that it has an evaluation routine subjecting the measuring results to at least one of a Fourier transform and an integration.

21. The impact force measuring means (4) according to claim 17, wherein a buffer memory is provided for temporary storage of measuring signals prior to processing by said microprocessor.

22. The impact force measuring means (4) according to claim 21, wherein said buffer memory is a ring buffer.

23. The impact force measuring means (4) according to integrated into a combat vest (2).

24. The impact force measuring means (4) according to claim 1 incorporated into boxing gloves.

25. The impact force measuring means (4) according to claim 1 incorporated into a blow training device.

26. A competition and/or training evaluation means comprising two combat vests (2), according to claim 23, to be worn by competitors, and a computer to which the impact data of the two combat vests are supplied, said computer being designed such that it is suitable to detect the impact data, to calculate scoring points form the impact data and to further process the scoring points in association with the individual competitors and to finally determine the winner.
